(19) United States
(12) Patent Application Publication
(10) Pub. No.: US 2009/0132319 A1
(43) Pub. Date: May 21, 2009

(54) METHOD FOR GENERATING AN ASSET LOADING PLAN

(75) Inventors: Baruch Ismail SAEED, Berkeley, CA (US); Geoffrey Alexander Boushey, San Francisco, CA (US); Zachary James Mided, San Francisco, CA (US)

Correspondence Address: SUGHRUE MION, PLLC, 2100 Pennsylvania Avenue, N.W., Washington, DC, 20037, US

(73) Assignee: Maxager Technology, Inc., San Rafael, CA (US)

(21) Appl. No.: 11/944,383

(22) Filed: Nov. 21, 2007

(51) Int. Cl. G06Q 10/00; G06F 17/00

(52) U.S. Cl. 705/8; 705/7; 705/10

(57) ABSTRACT

A method for generating an asset loading plan is provided. The method determines at high accuracy which products and sales orders to load on which assets (e.g., machines) in order to gain a maximum profit. Specifically, the method generates an optimized loading plan of sales orders that were produced and a least opportunity cost loading plan of sales orders that were not produced. In accordance with one embodiment the method generates a chart that shows, for each asset (or a set of assets), the cash contribution per minute versus the number of cumulative production minutes. In accordance with another embodiment the method computes the marginal cash contribution to determine the additional cash contribution that could be made if additional production time is allocated to a specific asset.

### TECHNICAL FIELD

The present invention generally relates to enterprise information systems, and, more particularly, it relates to a method for optimizing business planning.

### BACKGROUND OF THE INVENTION

In the competitive business climate, there is a profit-driven motive to maximize the profitability of goods and services that are provided or marketed to customers. Enterprises typically use business planning to make decisions in order to maximize profits.

Typically, business planning is the process of acquiring market and operational information from business units in the organization in order to create, integrate, and execute the next series of operational plans and financial budgets. The process normally entails the gathering of information by each logical organization of the business from logical sub-organizations, which in turn, themselves gather information from their sub-organizations, to a desired level of abstraction, usually at customer, product and process levels.

The business information is often aggregated from multiple data sources, such as individual spreadsheets, online transaction processing (OLTP) applications, and specialized databases, called operational data stores (ODS). The OLTP applications are enterprise systems that manage a company's basic transactions, such as supply chain management (SCM), customer relationship management (CRM), and enterprise resource planning (ERP). Using the business planning, tools managers can correctly make decisions that optimize resource allocation in order to maximize profits. For example, key decisions include, but are not limited to, determining which new products to introduce, which suppliers to use, which capital investments to make, and what prices to charge.

For a major asset (e.g., a machine), the loading of products is one problem that is resolved by business planning tools. The machine loading problem, as discussed in the related art (such as US published application 20060129462, June 2006, of Pankl, et al., which is incorporated by reference herein for its useful background information on this topic) is usually stated as the finding of the optimal assignment of jobs to machines such that the total profit is maximized and production is maintained within the machine capacities. This problem is highly important in plants that produce a variety of products usually in response to customers' sales orders. The plant includes a number of machines each of which is capable of processing one or more types of products or sub-assemblies thereof. However, the processing time and cost may vary from one machine to another for a given type of product or subassembly.

In the related art there are many conventional tools, such as linear programming or heuristic methods like material requirements planning, for implementing a business planning process to create a loading plan. These tools are often inadequate as they typically attempt to minimize cost or merely to find a feasible plan, rather than attempting to maximize profit by establishing the quantities and loadings of all sales orders. Some of the conventional tools also try to maximize the profit by usually aggregating product volumes and using averaged prices. However, such tools do not use detailed sales orders with their specific quantities and prices. That is, these tools typically determine only the quantities of products to produce on each machine. This result is insufficient, especially in production plants serving many customers with a large number of different product types and multiple interactive production flows. As a result, managers cannot make accurate strategic and tactical decisions regarding, for example, the production flows and asset loading.

### SUMMARY OF THE INVENTION

In view of the foregoing, it is an object of the invention to provide a more efficient solution for generating an asset loading plan. Other objects and purposes of the invention will become apparent from reviewing the description below.

### BRIEF DESCRIPTION OF THE DRAWINGS

The drawings help explain embodiments of the invention and are provided to help instruct those familiar with this field in the practical implementation of the invention. The drawings are directed to the person familiar with this field and, therefore, various details have been omitted so as to avoid obscuring the subject matter of the invention.

FIG. 1 is a flowchart describing the method for generating an optimized asset loading plan in accordance with an embodiment of the present invention.

FIGS. 2A through 2E are the output tables of the asset loading plan of products.

FIGS. 3 is a flowchart describing the processes for generating the loading plan of sales orders with quantities produced.

FIGS. 4A and 4B are the output tables of the loading plan of sales orders with quantities produced.

FIGS. 5A and 5B are the output tables of the loading plan of sales orders with quantities not produced.

FIGS. 6 is an output table that includes the details of the asset loading plan generated by the present invention.

FIGS. 7A is an asset loading chart generated by the present invention.

FIG. 7B is a cash contribution breakdown chart generated by the present invention.

FIG. 7C is a displaced-cash by asset chart generated by the present invention.

FIG. 8 is an actual versus plan marginal cash topological chart generated by the present invention.

FIG. 9 is a delivery-to locations map generated by the present invention.

### DETAILED DESCRIPTION OF THE INVENTION

The following detailed description teaches the invention by way of non-limiting, exemplary embodiments. The embodiments are not meant to define the limits of the invention but, rather, to instruct those familiar with this field in a practical implementation. The true scope of the invention should be ascertained with reference to the appended claims.

In order to overcome the shortcomings of prior art solutions, and provide solutions that overcome other problems not mentioned above, a method for generating an asset loading plan is provided. The method determines at high accuracy the quantities of each sales order to load on a particular asset (e.g., machine) in order to maximize profit. Specifically, the method generates an optimized loading plan of sales orders, in an optimal plan, with produced quantities. In addition, a least opportunity cost plan is generated for sales orders with non-produced quantities. For each such sales order, the method determines the most optimal and profitable processes and assets for a sales order. In accordance with one embodiment the method generates as an output a chart that shows for each asset (or a set of assets) the cash contribution per minute versus the cumulative number of production minutes. In accordance with another embodiment the method computes the marginal cash contribution to determine the additional cash contribution that could be made if additional production time is allocated to a specific asset.

The intended meaning of some of the terms used hereinafter will now be mentioned for the sake of explanation and not necessarily limitation. “Sales order” refers to a combination of product, customer, and deliver-to location with an associated price and a quantity. “Product” shall refer to an item to be produced. A Product may be a combination of several subassemblies, components or raw materials, and it may also be a non-storable service such as a BTU of energy or a person-day of consulting labor. “Asset” shall refer to an entity used to convert a product from one state (e.g., unassembled) to another state (e.g., assembled) over a period of time. An Asset may refer to a machine, a fixed form of conveyance (e.g., a pipeline), a form of labor, and so on. “Process step” refers to an operation in a production process needed to produce a product. A “Route” refers to a production sequence, more particularly a Route is a series of process steps, and each process step can be performed by one or more assets. “Reduced cost” is a linear programming term indicating the amount of the cost or price of a sales order needs to be adjusted in order to optimally load the sale order on an asset, process step and/or and route. The “Reduced Cost” reflects both sales order specific costs (e.g., revenue and production costs) and systemic costs (e.g., opportunity cost of resources that would have otherwise been allocated to other sales orders). “Marginal cash contribution per unit” shall refer to the marginal value of selling one more unit of a sales order's product. “Marginal cash contribution per minute” shall refer to the marginal cash that could be generated with an additional time-interval “minute” of an asset time. The minute is incremental to the available minutes for each asset, i.e., the number of minutes that the asset was available to produce products.

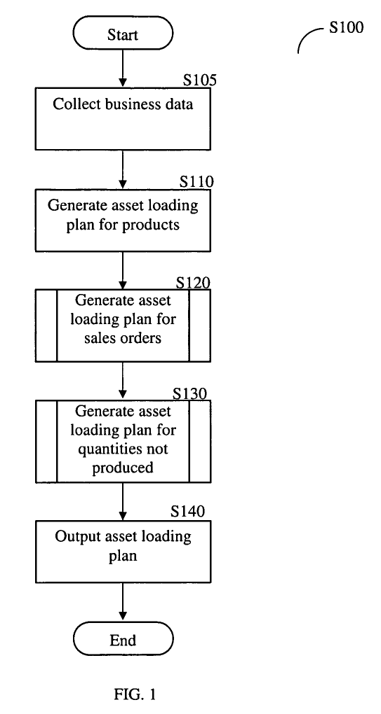

FIG. 1 shows an exemplary and non-limiting flowchart 100 describing the process of generating an optimized asset loading plan implemented in accordance with an embodiment of the present invention. At S105, the process receives as an input business data, from one or more production plants and a marketing and sales organization, collected from multiple data sources, such as those described above. The input business data may include finance data (e.g., production and shipping costs), marketing data (e.g., products), sales data (e.g., sales orders and their customers, products, prices and quantities), and production data (e.g., asset capabilities to make certain products, asset production rates, and asset capacities). The business data may be based on historical or projected details.

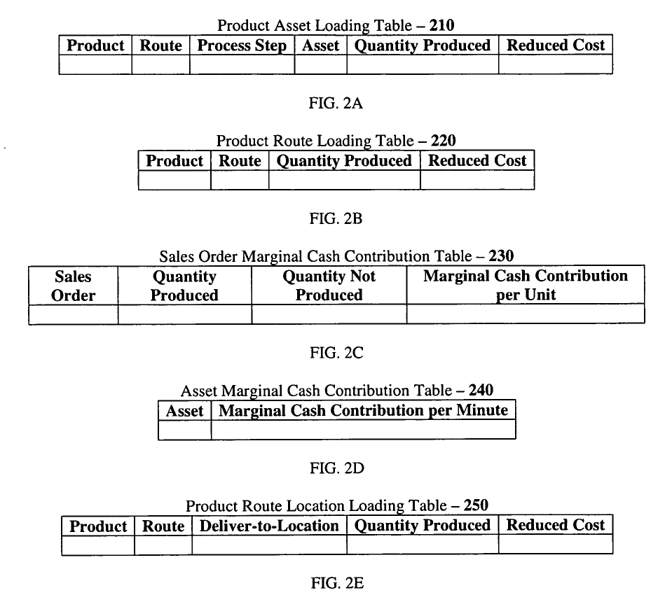

At S110, an optimized plan for loading products to assets is generated. The optimized plan is produced by using a mathematical programming (e.g., a linear programming) optimization engine based on the input business data. The linear programming optimization engine determines the best feasible values that satisfy a set of equations that represent various business factors and at the same time maximize the cash contribution measured by an objective function. The business factors may be related to, for example, demand, production flow, capacity, shipping, and attribute grouping. An example for the execution of S110 may be found in U.S. patent application Ser. No. 11/860,473 entitled “A method for business plan optimization based on attributes”, assigned to common assignee and is hereby incorporated by reference in its entirety. The outcome of S110 is at least a Product Asset Loading table. Specifically, as shown in FIG. 2A, a Product Asset Loading table 210 describes the assignment of products to routes, process steps, and assets. In addition, the table 210 includes the quantity produced for this product and its reduced cost. The outputs of S110 may further include a Product Route Loading table 220 (FIG. 2B), a Sales Order Marginal Cash Contribution table 230 (FIG. 2C), an Asset Marginal Cash Contribution table 240 (FIG. 2D), and a Product Route Location Loading table 250 (FIG. 2E). Table 210 includes the fields: product, route, process step asset, quantity produced, and reduced cost. Table 220 includes the fields: product, route, quantity produced, and reduced cost. Table 230 includes the fields: sales order, quantity produced, quantity not produced, and marginal cash contribution per unit. Table 240 includes the fields: asset, and marginal cash contribution per minute. Table 250 includes the fields: product, route, deliver-to-location, quantity produced, and reduced cost. These tables provide the business with an optimized plan.

The process described at S110 can be easily adapted by a person skilled in the art to develop a multi-period plan, where the step S110 is individually applied to each of the period with some exceptions discussed below. At S120, an optimized plan for loading produced sales orders' quantities to assets and routes is determined. A sales order includes a product to be delivered to a customer at a location, and therefore the loading of a sales order is different from a loading of a product. As an asset may not have sufficient time remaining to produce all of a product's units of a sales order, the production may be distributed across two or more assets at a process step or across two or more routes. Therefore, at S120, a Sales Order Route Loading table and a Sales Order Asset Loading table are generated. Furthermore, if an asset lacks sufficient availability, only a portion of a sales order's quantity may be produced.

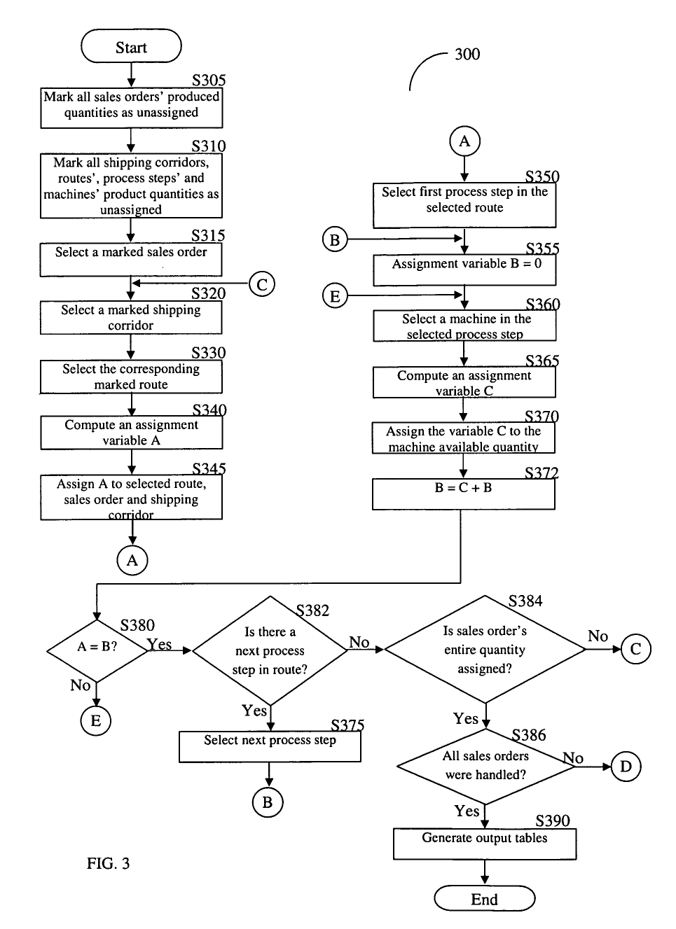

Referring now to FIG. 3, an exemplary and non-limiting flowchart 300, describing the process for generating the Sales Order Route Loading and Sales Order Asset Loading tables, is shown. The input of this process is the outputs of S110. At S305, all sales orders' produced quantities in Table 230 are marked as unassigned. At S310, all shipping corridors in Table 250 as well as product quantities of routes in Table 220, process steps and assets in Table 210 are marked as unassigned. A shipping corridor for a product is composed of a deliver-to location and a ship-from location. The deliver-to location is an attribute of the sales order, for example, the San Francisco, Calif. Airport. The ship-from location is an attribute of the end of the route, for example, a plant located in Fresno, Calif. At S315, a marked sales order is selected from Table 230.

At S320, a marked shipping corridor that delivers to the sales order's delivery location is selected. That is, for combination of a sales order's product and deliver-to-location, any marked corridor (i.e., a combination of product, route, and deliver-to-location) with unassigned quantity is selected from Table 250. At S330 the corresponding marked route is selected from Table 220.

At S340, a first assignment variable “A” is set to the minimum of the unassigned quantity of the selected sales order, the unassigned quantity of the selected shipping corridor, and the unassigned quantity of the selected route. It should be noted that the selected shipping corridor and route refer to a product of the selected sales order. At S345 the value of the variable A is assigned to the selected sales order, shipping corridor, route, and all process steps of the selected route. For example, if the unassigned quantities of the sales order, shipping corridor, and route are respectively 100, 120, and 90 units of a sales order's product, then the quantity 90 is assigned to this specific route, with the remainder of the sales order's quantity to be assigned to a different route later.

At S350 a first process step in the selected route is determined and, at S355, a second assignment variable “B” is initialized to zero. At S360, a machine in the process step with unassigned quantity of the sales order product is selected. At S365, a third variable “C” is set to the minimum assignment variable A minus assignment variable B, and the unassigned quantity of sales order's product of the selected machine, i.e.,

C=minimum{(A−B), machine's unassigned quantity of sales order's product}. (1.)

At S370 the value of the variable C is assigned to the unassigned quantity of the selected machine. In addition, at S372, the value of the assignment variable C is assigned to the value of the variable B (i.e., B←B+C, or B is set to B+C).

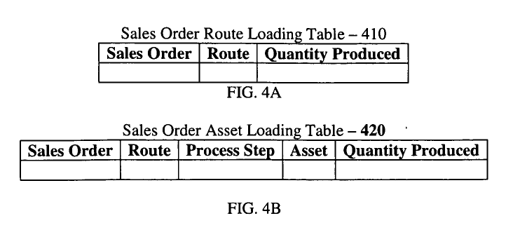

At S380 a check is made to determine if the assignment variable B equals to the assignment variable A, and if so, execution continues with S381; otherwise, execution returns to S360. At S382, another check is made to determine if there is a subsequent process step in the selected route, and if so execution continues with S375 where the next process step is selected, and thereafter execution continues with S355, where the variable B is set to zero; otherwise, execution continues with S384 where it is determined if the entire quantity of the selected sales order is assigned to asset(s), a route and a shipping corridor. If so, execution proceeds to S386; otherwise, execution returns to S320. At S386, a check is made to determine if all sale orders were handled, and if so execution continues with S390; otherwise, execution returns to S315 where another sales order with unassigned quantity is selected. At S390 the Sales Order Route Loading and Sales Order Asset Loading tables are generated using the asset(s), route(s) and process step(s) to each sales order. As shown in FIG. 4A a Sales Order Route Loading table 410 includes the fields: sales order, route, and quantity produced. A Sales Order Asset Loading table 420 provided in FIG. 4B includes the fields: sales order, route, process step, asset, and quantity produced.

It should be noted that the process 300 stays within the quantities resulting from a linear program, so the sum of the produced quantities for all sales orders for a process step and an asset always equals to volume produced on each process step and asset for all products.

In another embodiment of the present invention, a steps-and-transfers approach is used to generate the tables shown in FIGS. 4A and 4B. The steps-and-transfers approach comprises modeling individual process steps; identifying possible product transfers between the modeled process steps; and identifying assets operating within the modeled process steps to produce a product that can be transferred between the modeled process steps. It would be apparent to a person skilled in the art that a similarly recursive routine can be constructed to assign produced sales order quantities to process steps and assets.

Referring back to FIG. 1 where at S130 a loading plan of non-produced sales order quantities is determined. Specifically, as opposed to any prior art techniques, the quantities not produced of sales orders are identified and assigned to their least opportunity cost routes and assets. Typically, the loading step (e.g., step S110) assigns only sales order quantities in the optimal mix to assets. The optimal mix is determined by an optimization engine using the market and production data.

In accordance with one embodiment, a loading plan of non-produced sales order quantities is generated using reduced cost data. This is performed by using sensitivity (i.e., reduced cost) information on decision variables to find the most optimal assignment of a sales order to routes and assets. The decision variables may include, for example, volume produced of a sales order, volume produced of a product for a customer location; volume produced of a product for a customer location on a route; volume produced of a product on a route; and volume produced of a product on a route for a process step on an asset. Non-produced sales order quantities are assigned to feasible combinations of routes, process steps, and machines based on sums of their decision variables' reduced costs, i.e., the non-produced quantity of a sales order is assigned to its least opportunity cost combination.

In another embodiment of the present invention, sales orders not included in the optimal mix are assigned to assets and routes by running an optimization engine, while forcing the engine to add a portion of each such sales order to the optimal mix. This can be performed, for example, by assigning a very small minimum quantity to every sales order. Once the sales orders are added to the optimal mix, the loading process described at S120 assigns the volume produced to a route or asset, and any non-produced volume is assigned to the same routes, process steps, and assets corresponding to a sales order's produced quantity. It should be noted that in the case where a sales order is partially fulfilled, and the sales order is produced on multiple routes or multiple assets within a process step, the non-produced quantity will be assigned to routes, process steps, and assets in the same proportions as the optimally produced quantities.

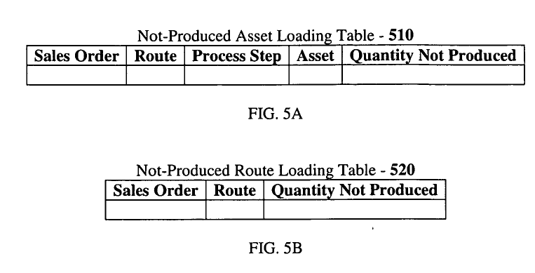

The outcome of step S130 is a Sales Order Quantity Not-Produced Asset Loading table 510 and a Not-Produced Sales Order Quantity Route Loading table 520 which are shown in FIGS. 5A and 5B respectively. The table 510 includes the fields: sales order, route, process step, and quantity not produced. The table 520 includes the fields: sales order, route, assets and quantity not produced.

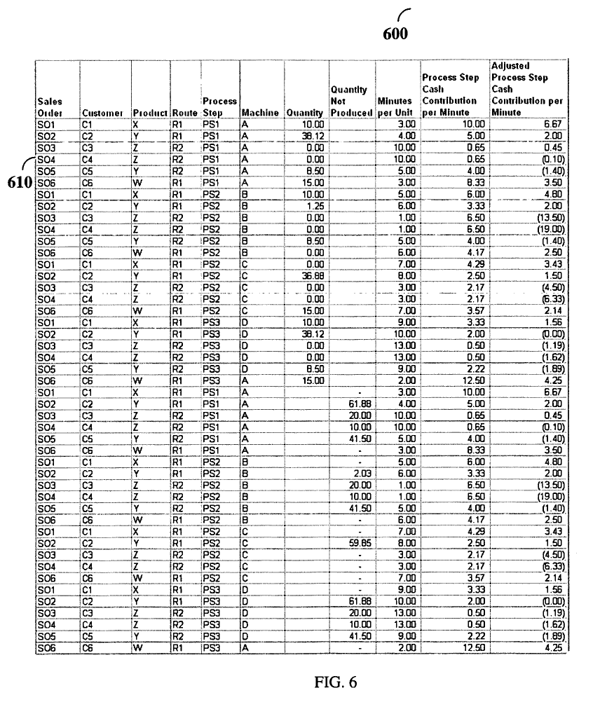

Referring back to FIG. 1 where at S140 the details of the generated asset loading plan are output. Specifically, these details are arranged in a table that includes at least the fields: sales order, customer, product, route, process step, asset, quantity produced, quantity not produced, minutes per unit, process step cash contribution per minute, adjusted process step cash contribution per minute, and asset (or machine) marginal cash contribution per minute. An exemplary output table 600 is provided in FIG. 6. The table 600 splits rows into Quantity and Quantity Not Produced row. If the respective quantity in one row is positive, then its value in the other row is zero. The sum of all Quantity and Quantity Not Produced in all rows for a sales order equals to the sales order's maximum quantity. If there are sales orders with zero quantity produced under an optimal plan, then table 600 indicates the routes, process steps and assets that would be used to produce the sales orders if these sales orders were forced into production, while minimizing the negative impact on profitability (i.e., systemic cash contribution). For example, row 610 with a sales order “SO4” in the above table is an example of such a case. The sales order “SO4” had a Quantity produced equals to zero, i.e., products were not produced; however, the route, process step, and asset assigned to this sales order are R2, PS2, and B respectively.

The Asset-Process Step Cash Contribution per Minute is calculated for a given Sales Order on a Route at a Process Step on an Asset. The calculation is performed using the following equation:

Asset-Process Step Cash Contribution per Minute=Sales Order's Cash Contribution per Unit/Minutes per Unit for the selected asset to produce the product at the process step (2.)

As mentioned above multi-period planning can be performed to solve at least machine loading with inventory problems. In such a case, the Asset-Process Cash Contribution per Minute for a given “current” period is calculated as follows:

Asset-Process Step Cash Contribution per Minute=(sales order's Price−sales order's Variable Cost)/Minutes per Unit for the selected asset to produce the product at the process step (3.)

where, the sales order's Price is discounted to the current period. Similarly, if inventory exists prior to the current planning period, the inventory's Variable Cost is a sunk cost, and the same equation, with a non-discounted Price and Variable Cost replaced by 0, is applied to compute the Asset-Process Step Cash Contribution per Minute.

The Asset-Process Step Adjusted Cash Contribution per Minute is calculated for a given Sales Order on a route at a process step on an asset. The calculation is performed, for example, using the following equation:

Asset-Process Step Adjusted Cash Contribution per Minute=(Sales Order's Marginal Cash Contribution per Unit/Minutes per Unit for the selected asset to produce the product at the process step)+Asset Marginal Cash Contribution per Minute (4.)

The Asset Process Step Marginal Cash Contribution per Minute is calculated for a given Sales Order on a route at a process step on an asset. The calculation is performed, for example, using the following equation:

Asset-Process Step Marginal Cash Contribution per Minute=Sales Order's Marginal Cash Contribution per Unit/Minutes per Unit (5.)

The “Minutes per Unit” parameter is for the selected asset to produce the product at the process step.

It should be noted that a sales order's Marginal Cash Contribution per Unit reflects information about the timing of when the sales order's product was produced and when the sales order was sold. As mentioned above, inventory could be built in a prior planning for use by the sales order in the current period, and appropriate inflating of variable costs would be reflected in the Marginal Cash Contribution per Minute.

It would be apparent to a person skilled in the art that the tables and their content can be presented in the form of charts, or any other tangible format in print, display, or otherwise.

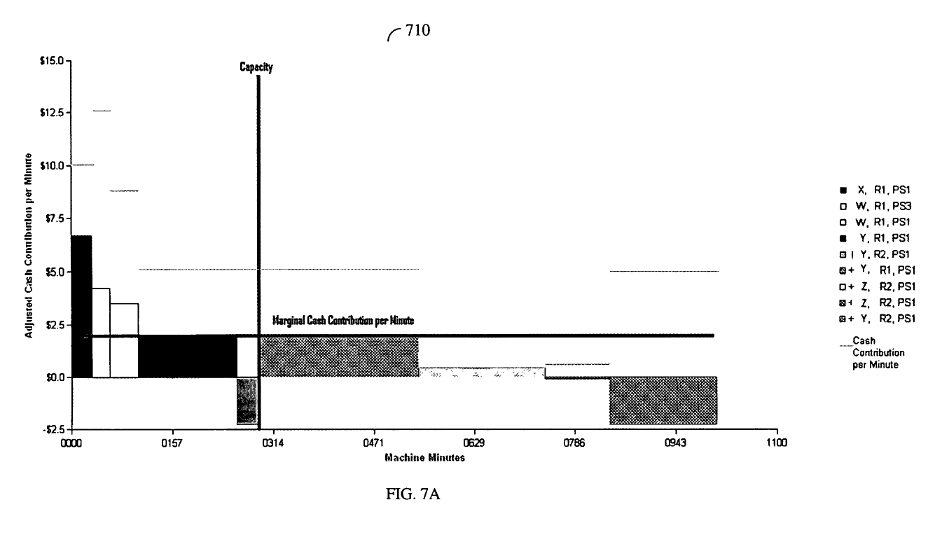

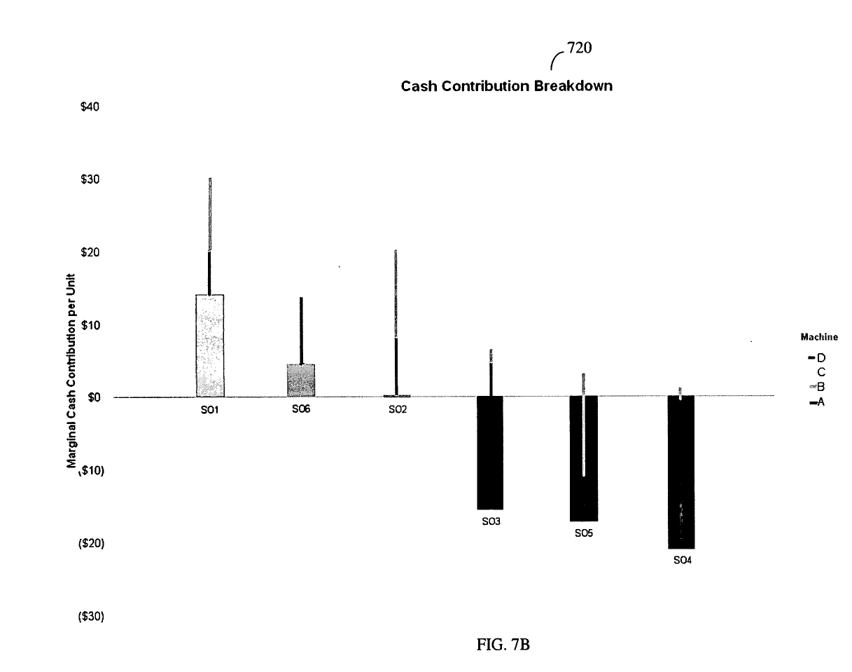

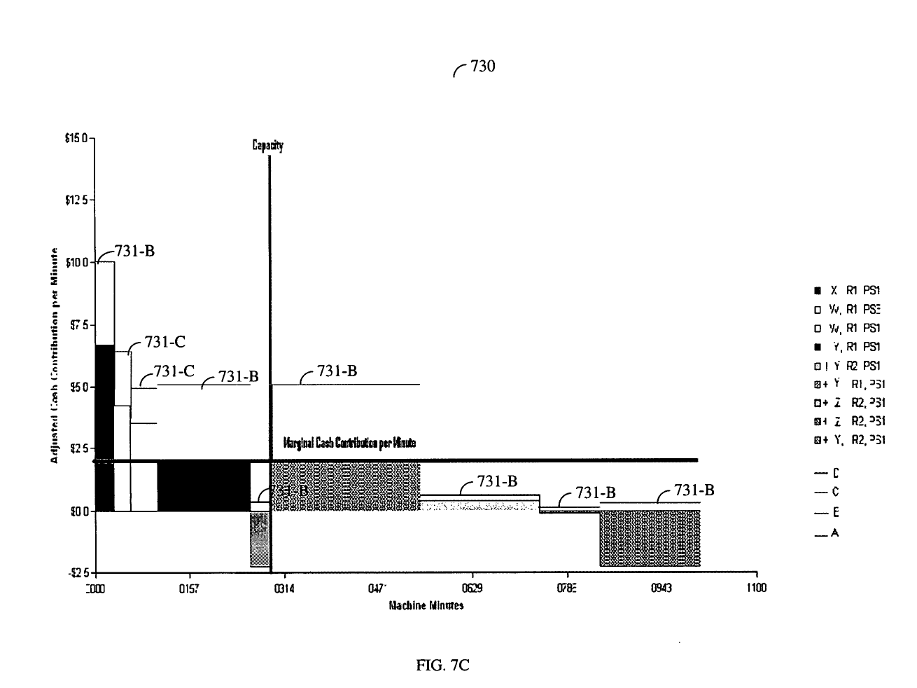

In a preferred embodiment of the present invention the outputs generated by the process 100 can be displayed through a plurality of charts. Non-limiting examples of such charts are provided in FIGS. 7A through 7C.

FIG. 7A shows an asset loading chart 710 which illustrates why certain products were loaded on certain assets. This chart may be constructed for one asset, or a set of similar assets, and it may be shown at the individual sales order detail, or aggregated at a higher level such as a product, product group, customer or customer group. The chart 710 displays the cumulative asset minutes versus the asset-process step adjusted cash contribution per minute for each combination of product, route and process step. For example, as can be clearly noticed from chart 710, it is more profitable to load product X (at Route R1 and process step PS1) rather product Y (at Route R2 and process step PS1). A sales order's asset minutes may be calculated as follows:

Asset Minutes=Quantity*Minutes per Unit (6.)

FIG. 7B is a cash contribution breakdown chart 720 which shows the marginal cash contribution per unit for sales orders. The positive and negative bars represent the marginal cash contribution per unit for the sales orders with respect to the values of Quantity Produced and Quantity Not Produced. The stacked lines show the displaced cash per unit by asset. This value describes the cash contribution if the production of a product is displaced at another asset.

A displaced-cash by asset chart 730 is provided in FIG. 7C. The chart 730 is an asset loading chart (e.g., chart 710) with additional line boxes (labeled as “731”) above the original bars. The line boxes 731 indicate how much of the given bar's cash contribution is displaced at another asset (i.e., the opportunity cost at another asset). For example, the line 731-B shows the cash contribution if the product “X” would be produced on a machine “B” instead of machine “A”. The sum of the heights of the bar and the boxes equals the total cash contribution per minute. The width of each line box is the same as the width of its underlying bar. The incremental height of a line box relative to the line box beneath it is the other asset's cash displaced per minute on the current asset for a sales order, and it may be computed using, for example, the following equation:

$$Other Asset ' s Cash Displaced per Minute on Current Asset = \frac{Cash Displaced on other Asset}{( Quantity * Minutes per Unit on Current Asset )} \qquad ( 7. )$$

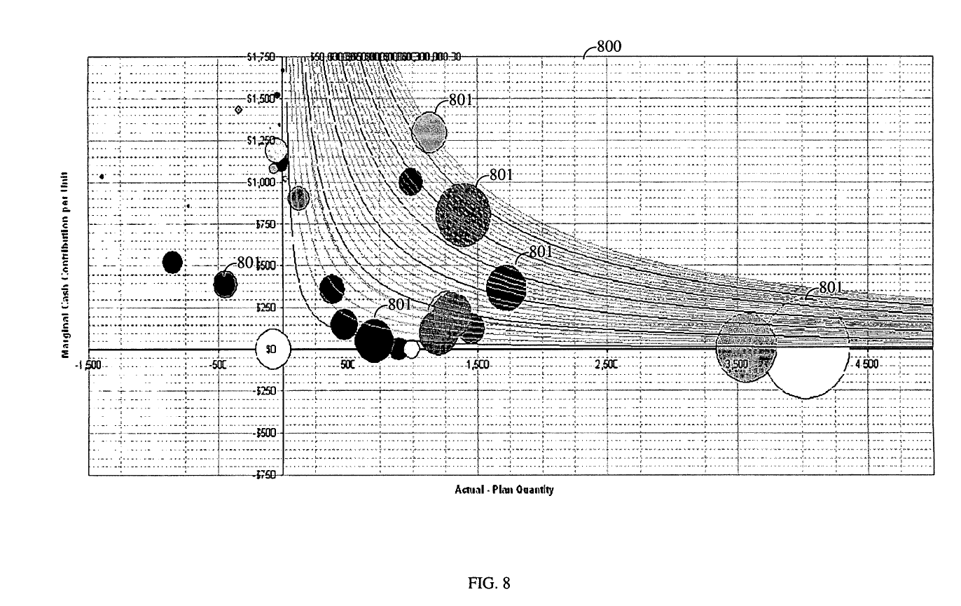

In another embodiment a topographical chart showing the actual versus plan marginal cash per unit is generated. A non-limiting example for such chart 810 is provided in FIG. 8. The ‘x’ axis of chart is the difference in quantity between the actual and plan quantity to be produced. The ‘y’ axis is the marginal cash contribution per unit as determined by the sales order marginal cash. The topographical lines show points on the chart where x-axis values multiplied by y-axis values equal to a constant value. It should be noted that x-axis may be any of: difference between actual and plan quantity, difference between actual and plan revenue, units per minute, and so on. The y-axis may be any of: cash contribution per unit, adjusted cash contribution per unit, marginal cash contribution per unit, cash contribution per dollar revenue, adjusted cash contribution per dollar revenue, marginal cash contribution per dollar revenue, and so on. However, to have meaningful topographical lines, the denominator units of the y-axis must always match the numerator units on the x-axis. The size of the bubbles (labeled “801”) may be units, revenue, and so on. Each bubble may represent a sales order, customer, product, customer-product combination, customer segment, product group, and so on. It should be further noted that the topographical lines may appear in all quadrants.

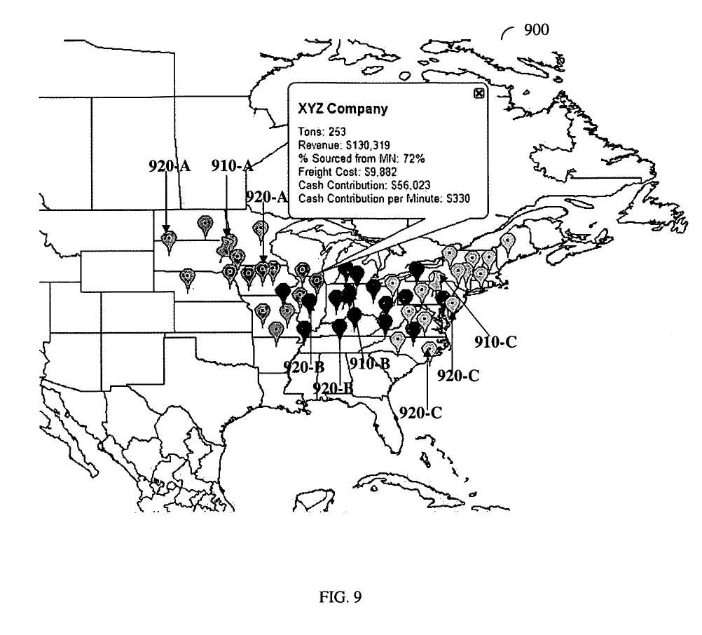

In another embodiment a delivery-to locations map is generated. An exemplary map 900 is provided in FIG. 9. The map 900 shows which deliver-to locations were fulfilled by which ship-from locations (i.e., plants). The “pins” labeled as 910 represent the plants and the “balloons” labeled 920 show the deliver-to locations. If a plant 910 and a deliver-to location 920 have the same color, most of the product shipped to the deliver-to location was produced by the plant. The coloring may be determined by any one of various metrics, such as quantity, cash contribution and revenue. The example shows that most associations of deliver-to locations with plants are based on proximity, with a few exceptions. Explorations of individual deliver-to locations and plants are possible via a selection device such as a computer mouse.

The methods and processes described herein can be implemented in software, hardware, firmware or any combination thereof The product may be further included in a product that contains a plurality of instructions on a computer readable medium, and the instructions may be loaded into a memory by a device such as a processor of a computer system. The computer system thereby is enabled to support the performance of some or all of the instructions and as a result executing the methods disclosed herein above.

1. A computer implemented method for generating an optimized asset loading plan, comprising:
collecting business data of an organization;
based on the business data, generating:
a loading plan of products;
a loading plan of produced sales orders quantities;
a loading plan of non-produced sales orders quantities; and
outputting the optimized asset loading plan in accordance with the generated loading plans.

2. The method of claim 1, where the business data comprises at least one of: finance data, marketing data, sales data, and production data.

3. The method of claim 2, wherein the business data is based on at least one of: historical details and projected details.

4. The method of claim 1, wherein generating the loading plan of products further comprises assigning products to assets, routes, and process steps.

5. The method of claim 4, wherein the loading plan of products is generated using a mathematical programming engine.

6. The method of claim 1, wherein generating the loading plan of produced sales orders quantities further comprises, for each sales order:
assigning the quantities produced of the sales order to a least one route and its process steps; and
assigning the quantities produced of the sales order to a least one asset in each of the process steps of the least one route.

7. The method of claim 1, wherein generating the loading plan of produced sales orders quantities further comprises:
modeling individual process steps;
identifying possible product transfers between the modeled process steps; and
identifying assets operating within the modeled process steps to produce a product that can be transferred between the modeled process steps.

8. The method of claim 7, wherein generating the loading plan of non-produced sales orders quantities further comprises,
for each sales order:
assigning the non-produced quantities of the sales order to a least one route and its associated process steps according to the least opportunity cost of the sales order; and
assigning the non-produced quantities of the sales order to at least one asset for each of the route's process steps according to the least opportunity cost of the sales order.

9. The method of claim 1, wherein outputting the optimized asset loading plan comprises the production of at least one of the following outputs: a sales order, a customer, a product, a route, a process step, an asset, a quantity produced, a quantity not produced, a minutes per unit, a process step cash contribution per minute, an adjusted process step cash contribution per minute, and an asset marginal cash contribution per minute.

10. The method of claim 8, wherein the outputs further indicate for sales orders with quantities not produced the routes, process steps and assets that would be used to produce the sales orders' non-produced quantities if the quantities were forced into production.

11. The method of claim 8, wherein outputting the optimized asset loading plan comprises the production of at least one of the following charts as an output: an asset loading chart, a cash contribution breakdown chart, a displaced-cash by asset chart, a topographical chart of a marginal cash per unit.

12. The method of claim 11, wherein the output is displayed or printed.

13. The method of claim 1, further comprising taking business decisions regarding products, customers, asset loading and production flows based on the optimized business plan.

14. A computer program product for generating an optimized asset loading plan, the computer program product having computer instructions on a tangible computer readable medium, the instructions being adapted to enable a computer system to perform operations, comprising:
collecting business data of an organization;
based on the business data, generating:
a loading plan of products;
a loading plan of produced sales orders quantities;
a loading plan of non-produced sales orders quantities; and
outputting the optimized asset loading plan in accordance with the generated loading plans.

15. The computer program product of claim 14, where the business data comprises at least one of: finance data, marketing data, sales data, and production data.

16. The computer program product of claim 15, wherein the business data is based on at least one of: historical details and projected details.

17. The computer program product of claim 14, wherein generating the loading plan of products further comprises assigning products to assets, routes, and process steps.

18. The computer program product of claim 14, wherein generating the loading plan of produced sales orders quantities further comprises for each sales order:
assigning the quantities produced of the sales order to a least one route and its process steps; and
assigning the quantities produced of the sales order to a least one asset in each of the process steps of the at least on route.

19. The computer program product of claim 14, wherein generating the loading plan of produced sales orders quantities further comprises:
modeling individual process steps;
identifying possible product transfers between the modeled process steps; and
identifying assets operating within the modeled process steps to produce a product that can be transferred between the modeled process steps.

20. The computer program product of claim 19, wherein generating the loading plan of non-produced sales orders quantities further comprises:
for each sales order,
assigning the non-produced quantities of the sales order to a least one route and its associated process steps according to the least opportunity cost of the sales order; and
assigning the non-produced quantities of the sales order to at least one asset for each of the route's process steps according to the least opportunity cost of the sales order.

21. The computer program product of claim 14, wherein outputting the optimized asset loading plan comprises the production of at least one of the following outputs: a sales order, a customer, a product, a route, a process step, an asset, a quantity produced, a quantity not produced, a minutes per unit, a process step cash contribution per minute, an adjusted process step cash contribution per minute, and an asset marginal cash contribution per minute.

22. The computer program product of claim 20, wherein the outputs further indicate for sales orders with quantities not produced the routes, process steps and assets that would be used to produce the sales orders' non-produced quantities if the quantities were forced into production.

23. The computer program product of claim 20, wherein outputting the optimized asset loading plan comprises the production of at least one of the following charts as an output: an asset loading chart, a cash contribution breakdown chart, a displaced-cash by asset chart, a topographical chart of a marginal cash per unit.

24. The computer program product of claim 23, wherein the output is displayed or printed.

25. The computer program product of claim 14, further comprising taking business decisions regarding products, customers, asset loading and production flows based on the optimized business plan.

26. The computer program product of claim 17, wherein the loading plan of products is generated using a mathematical programming engine.
